(19) United States
(12) Patent Application Publication
(10) Pub. No.: US 2023/0262548 A1
(43) Pub. Date: Aug. 17, 2023

(54) RADIO COMMUNICATION CONTROL DEVICE AND RADIO COMMUNICATION CONTROL METHOD

(71) Applicant: Fujitsu Limited, Kawasaki-shi (JP)

(72) Inventors: Kenichi NISHIKAWA, Kawasaki (JP); Kazuyuki Ozaki, Yokohama (JP)

(73) Assignee: Fujitsu Limited, Kawasaki-shi (JP)

(21) Appl. No.: 17/979,844

(22) Filed: Nov. 3, 2022

(30) Foreign Application Priority Data
Feb. 14, 2022 (JP) 2022-020800

(51) Int. Cl. H04W 36/00; H04W 36/32

(52) U.S. Cl. CPC H04W 36/00837; H04W 36/32

(57) ABSTRACT

A radio communication control device controls handover of a user terminal in a radio communication system including a base station and a mobile relay station. The radio communication control device includes a processor. The processor determines whether a handover condition is satisfied based on received power of a radio signal detected by the user terminal. The radio signal is transmitted from the base station or the relay station. The processor estimates first communication amount representing communication amount of the user terminal in an estimation period in a case where the handover is executed and second communication amount representing communication amount of the user terminal in the estimation period in a case where the handover is not executed. The processor controls execution of the handover when the handover condition is satisfied and the first communication amount is larger than the second communication amount.

### CROSS-REFERENCE TO RELATED APPLICATION

This application is based upon and claims the benefit of priority of the prior Japanese Patent Application No. 2022-020800, filed on Feb. 14, 2022, the entire contents of which are incorporated herein by reference.

### FIELD

The embodiments discussed herein are related to a radio communication control device and a radio communication control method for controlling a handover of a user terminal.

### BACKGROUND

In radio communication using a millimeter wave or a terahertz wave, a propagation loss is large. Therefore, in order to ensure a sufficient radio coverage area, it is preferable that communication equipment includes an antenna with a high gain or high-power device for increasing effective radiation power. However, since the user terminal is required to be reduced in size and power consumption in many cases, it is difficult to implement the antenna with a high gain and/or the high-power device in the user terminal.

For such a reason, a sufficient radio coverage area sometimes cannot be secured. In particular, the performance of an uplink for transmitting a signal from the user terminal to a base station may be deteriorated. In this case, a difference in communication performance between the uplink and a downlink increases. Therefore, a radio communication system including a mobile relay device has been proposed. Note that, in the following description, the mobile relay device may be referred to as “mobile relay device” or simply as “relay station”.

The relay station is implemented in, for example, a vehicle or a drone and relays communication between the base station and the user terminal. The position of the relay station is controlled by, for example, the base station. Accordingly, the base station can arrange the relay station in, for example, an area with a poor radio wave environment or an area where many user terminals operate. Consequently, a sufficient radio coverage area can be secured. In particular, the performance of the uplink can be improved.

Note that a mobile relay device that relays communication between a radio base station and a communication terminal is described in, for example, Japanese Laid-open Patent Publication No. 2021-007192 and International Publication Pamphlet No. WO2020/202341.

As explained above, the performance of the uplink can be improved by arranging the relay station in an appropriate position. However, when the position of the relay station changes, the path loss between the relay station and the user terminal also changes. Here, in many cases, handover is controlled based on received power (for example, RSRP: Reference Signal Received Power) in the user terminal. For this reason, in the radio communication system in which the position of the relay station may change, occurrence frequency of the handover sometimes increases. Since data communication is interrupted when the handover is executed, throughput decreases when the occurrence frequency of the handover increases. That is, in a radio communication system using a mobile relay station, a transmission capacity sometimes decreases when the frequency of the handover increases.

### SUMMARY

According to an aspect of the embodiments, a radio communication control device controls handover of a user terminal in a radio communication system including a base station and a mobile relay station. The radio communication control device comprising a processor configured to determine whether a handover condition is satisfied based on a received power of a radio signal detected by the user terminal, the radio signal being transmitted from the base station or the relay station, estimate a first communication amount representing a communication amount of the user terminal in an estimation period in a case where the handover is executed and a second communication amount representing a communication amount of the user terminal in the estimation period in a case where the handover is not executed, and control an execution of the handover of the user terminal when the handover condition is satisfied and the first communication amount is larger than the second communication amount.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIGS. 1A to 1C illustrate an example of a radio communication system according to an embodiment of the present disclosure;

FIG. 2 illustrates an example of a handover sequence;

FIGS. 3A and 3B illustrate an example of a method of determining whether to execute handover based on throughput;

FIG. 4 illustrates an example of a radio communication control device according to the embodiment of the present disclosure;

FIG. 5 is a flowchart illustrating an example of a radio communication control method according to the embodiment of the present disclosure;

FIG. 6 illustrates an example of a parameter for correcting an estimated value of throughput;

FIG. 7 is a diagram for explaining an estimation of a transmission path; and

FIG. 8 is a diagram for explaining a calculation of an SINR.

### DESCRIPTION OF EMBODIMENTS

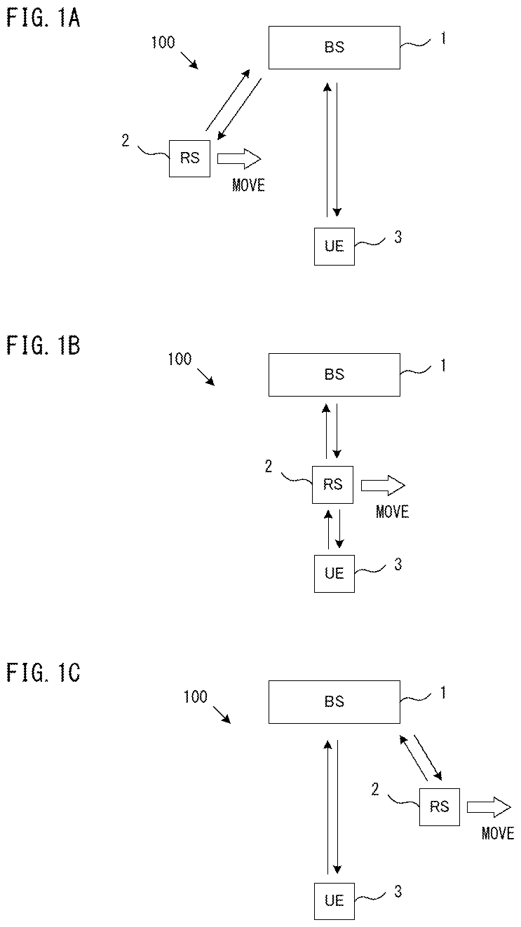

FIGS. 1A to 1C illustrate an example of a radio communication system according to an embodiment of the present disclosure. In this example, a radio communication system 100 includes a base station (BS) 1, a relay station (RS) 2, and a user terminal (UE: user equipment) 3. Note that the radio communication system 100 may include a plurality of relay stations 2, and/or a plurality of user terminals 3.

The base station 1 can accommodate one or a plurality of user terminals 3. The base station 1 can accommodate one or a plurality of relay stations 2. Note that the base station 1 is not particularly limited but is, for example, an eNodeB supporting 4G or a gNodeB (an NR base station) supporting 5G. The relay station 2 relays communication between the base station 1 and the user terminal 3. The relay station 2 can move. For example, the relay station 2 is mounted on a vehicle or a drone. The position of the relay station 2 is controlled by the base station 1. Accordingly, the base station 1 can arrange the relay station 2 in, for example, an area with a poor radio wave environment or an area where many user terminals 3 operate. Consequently, a sufficient radio coverage area is secured. Note that the base station 1 may further control the direction of transmission/reception beams of the relay station 2.

The base station 1 and the relay station 2 respectively periodically output reference signals. Transmission power of the reference signal is determined in advance. The user terminal 3 measures or detects a received power (RSRP: Reference Signal Received Power) of the reference signals transmitted from the base station 1 and the relay station 2. The base station 1 can determine based on the RSRP measured by the user terminal 3 whether to execute handover. Note that, in the following description, the base station 1 and the relay station 2 may be collectively referred to as “BS/RS”.

For example, in FIG. 1A, the user terminal 3 is connected to the base station 1 not via the relay station 2. At this time, the base station 1 and the relay station 2 respectively periodically output reference signals. The user terminal 3 measures RSRPs of the reference signals transmitted from the base station 1 and the relay station 2. Note that it is assumed that the relay station 2 is moving in a direction indicated by an arrow.

As illustrated in FIG. 1B, when the relay station 2 approaches the user terminal 3, the RSRP of the reference signal received from the relay station 2 becomes larger than the RSRP of the reference signal received from the base station 1 in the user terminal 3. In this case, the base station 1 determines that a handover condition is satisfied and executes handover from the base station 1 to the relay station 2. As a result, the user terminal 3 is connected to the relay station 2. That is, the user terminal 3 is connected to the base station 1 via the relay station 2.

Thereafter, as illustrated in FIG. 1C, when the relay station 2 moves away from the user terminal 3, the RSRP of the reference signal received from the relay station 2 becomes smaller than the RSRP of the reference signal received from the base station 1 in the user terminal 3. In this case, handover from the relay station 2 to the base station 1 is executed. That is, the user terminal 3 is connected to the base station 1 not via the relay station 2.

In this manner, the user terminal 3 is connected to the BS/RS having larger RSRP. Accordingly, the user terminal 3 can perform communication via a link with high communication performance.

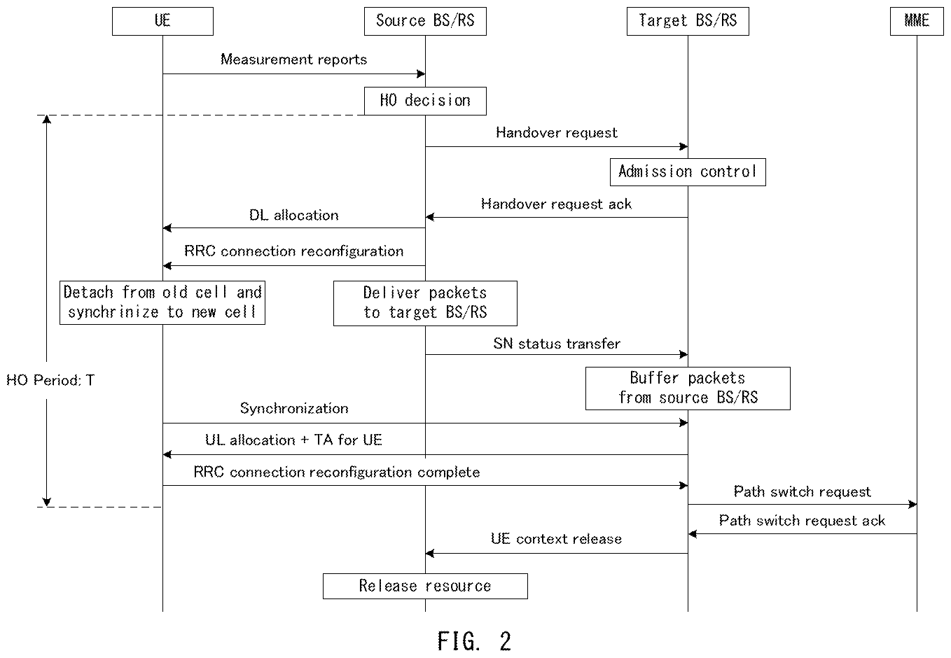

FIG. 2 illustrates an example of a handover sequence.

In this example, a user terminal (UE) is connected to a source BS/RS. Then, the user terminal periodically creates measurement reports representing the RSRPs of the reference signals transmitted from the BS/RSs and transmits the measurement reports to the source BS/RS.

The source BS/RS determines based on the measurement reports received from the user terminal whether to perform handover. In this example, RSRP of a reference signal received from a target BS/RS is larger than RSRP of a reference signal received from the source BS/RS. In this case, the source BS/RS determines that handover from the source BS/RS to the target BS/RS should be performed. Note that the source BS/RS represents a base station or a relay station to which the user terminal is connected. That is, the source BS/RS is an example of a serving station.

The source BS/RS transmits a handover request to the target BS/RS. The handover request includes information for identifying the relevant user terminal. Then, after performing admission control, the target BS/RS transmits a handover request ACK to the source BS/RS.

The source BS/RS transmits downlink allocation information to the user terminal. In addition, the source BS/RS transmits RRC connection reconfiguration information to the user terminal. Then, the user terminal executes detachment from an old cell and synchronization with a new cell. The source BS/RS transmits a packet buffered in a memory of the source BS/RS to the target BS/RS. The target BS/RS stores the packet received from the source BS/RS in a memory of the target BS/RS.

The user terminal transmits synchronization information to the target BS/RS. The target BS/RS transmits uplink allocation information and a timing advance command (TA for UE) to the user terminal. Further, the user terminal transmits a message representing completion of RRC connection reconfiguration to the target BS/RS.

Thereafter, the target BS/RS transmits a path switch request to an MME (Mobility Management Entity). The MME transmits a path switch request ACK to the target BS/RS. The target BS/RS instructs the source BS/RS to release a resource. The source BS/RS releases a resource allocated to the user terminal. Consequently, a handover procedure is completed.

As explained above, in the sequence illustrated in FIG. 2, it is determined based on the RSRPs whether to execute handover. Specifically, when the RSRP of the reference signal received from the target BS/RS is larger than the RSRP of the reference signal received from the source BS/RS in the user terminal, it is determined that the handover from the source BS/RS to the target BS/RS should be performed. However, in a method of determining whether to execute handover based on only the RSRPs, it is likely that throughput is deteriorated because of the handover. Therefore, in the radio communication control method according to the embodiment of the present disclosure, it is determined whether to execute handover considering the throughput of the user terminal in addition to the RSRPs.

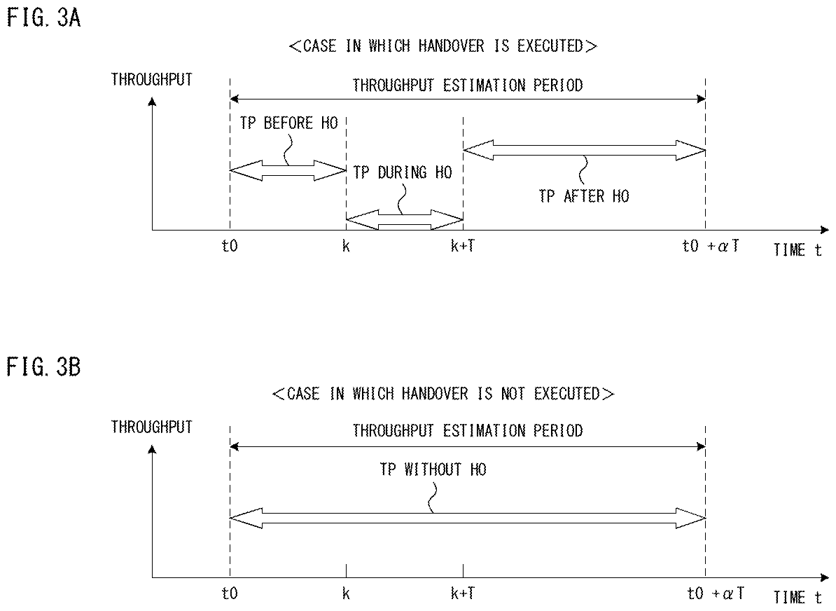

FIGS. 3A and 3B illustrate an example of a method of determining whether to perform handover based on throughput. Note that the horizontal axis represents time. “t0” represents current time. “k” represents a time when a handover procedure is started. “T” represents a period in which data transmission of the user terminal is interrupted because of the handover. The period T is equivalent to a handover period T illustrated in FIG. 2. The handover period T is not particularly limited but is, for example, approximately 10 ms. “α” is a coefficient for designating a period in which throughput is estimated. The coefficient α is set beforehand by a simulation or the like. Note that α is larger than 1. As an example, a value of α may be 5 to 10. The vertical axis represents the throughput of the user terminal.

When determining whether to execute handover based on throughput, the radio communication control device according to the embodiment of the present disclosure estimates a communication data amount in a period from time t0 to time t0+αT. Specifically, the radio communication control device estimates communication data amounts in the period from the time t0 to the time t0+αT respectively for a case in which handover is executed and a case in which handover is not executed. Note that, in the following description, the period from the time t0 to the time t0+αT is sometimes referred to as “throughput estimation period”. The throughput estimation period represents a period in which a communication amount (a communication data amount or throughput) is estimated.

As illustrated in FIG. 3A, the throughput estimation period includes first to third periods. The first period represents a period from the current time t0 to time k. Time k is a time at which the handover condition based on the received power is satisfied. In other words, time k may be a predicted time at which RSRP of target BS/RS becomes larger than RSRP of the serving BS/RS. The second period represents a period from the end of the first period (that is, time k) until the handover execution period T elapses. The third period represents a period from the end of the second period (that is, k+T) to the end of the throughput estimation period.

In the case in which handover is executed, the radio communication control device estimates throughput TP_before_HO, throughput TP_during_HO, and throughput TP_after_HO illustrated in FIG. 3A. The throughput TP_before_HO represents throughput of the user terminal in a period from the current time until a handover procedure is started. The throughput TP_during_HO represents throughput of the user terminal in a period in which the handover procedure is executed. The throughput TP_after_HO represents throughput of the user terminal in a period from when the handover procedure ends until the throughput estimation period ends. Note that the throughput TP_before_HO is equivalent to throughput of communication from the user terminal to the source BS/RS. The throughput TP_after_HO is equivalent to throughput of communication from the user terminal to the target BS/RS. The throughput TP_during_HO may be substantially zero in this embodiment.

In the case in which handover is not executed, the radio communication control device estimates throughput TP_without_HO illustrated in FIG. 3B. That is, the throughput TP_without_HO represents throughput of communication from the user terminal to the source BS/RS during the throughput estimation period in the case in which it is assumed that handover from the source BS/RS to the target BS/RS is not executed.

A communication data amount in the throughput estimation period is calculated from the throughputs explained above. For example, a communication data amount in the case in which handover is executed is represented by Formula (1). Note that it is assumed that throughput during handover procedure is zero.

Data amount(with HO)=Data amount(TP before HO)+Data amount(TP after HO) (1)

A communication data amount in the case in which handover is not executed is represented by Formula (2).

Data amount(without HO)=Data amount(TP without HO) (2)

The radio communication control device compares the Data_amount(with HO) and the Data_amount(without HO). That is, a communication data amount of the user terminal in a case where handover is executed and a communication data amount of the user terminal in a case where handover is not executed are compared. When the Data_amount(with HO) is larger than the Data_amount(without HO), it is determined that a communication data amount in the throughput estimation period is larger when handover is executed. In this case, the radio communication control device instructs execution of handover. On the other hand, when the Data_amount(with HO) is smaller than the Data_amount(without HO), it is determined that the communication data amount in the throughput estimation period is smaller when handover is executed. In this case, the radio communication control device does not instruct execution of handover.

As explained above, in the radio communication control method according to the embodiment of the present disclosure, it is determined whether to execute handover considering the throughput of the user terminal in addition to received power. Therefore, a situation in which throughput is deteriorated by executing handover is avoided or suppressed.

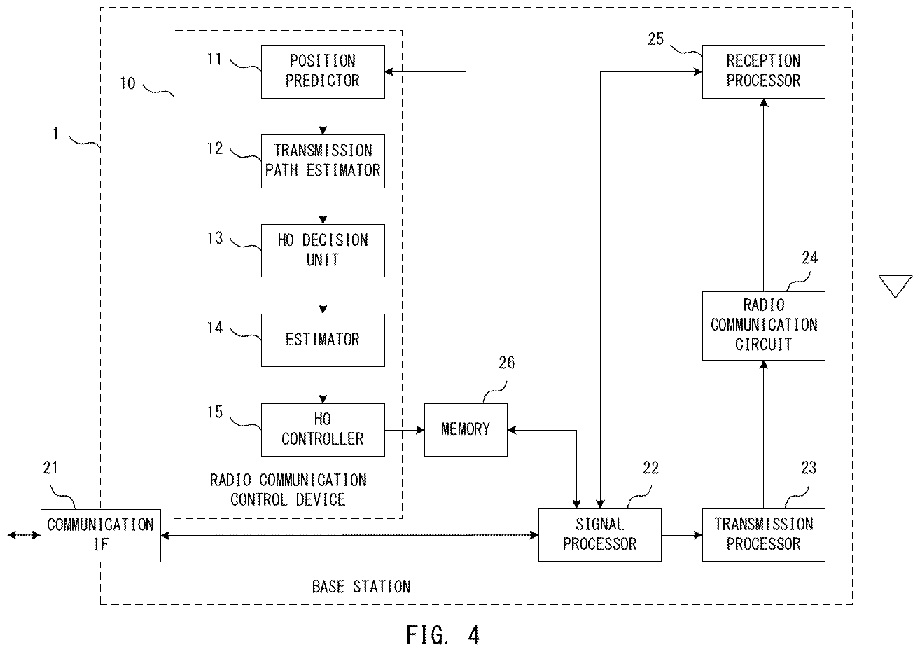

FIG. 4 illustrates an example of the radio communication control device according to the embodiment of the present disclosure. In this example, a radio communication control device 10 according to the embodiment of the present disclosure is implemented in the base station 1. However, the embodiment of the present disclosure is not limited to this configuration. For example, the radio communication control device 10 may be implemented in the relay station 2.

The base station 1 includes a communication interface 21, a signal processor 22, a transmission processor 23, a radio communication circuit 24, a reception processor 25, a memory 26, and the radio communication control device 10. Note that the base station 1 may include other functions or circuits not illustrated in FIG. 4.

The communication interface 21 can be connected to other base stations and MMEs via a network. The signal processor 22 generates a message to be transmitted to the relay station 2 and the user terminal 3. The signal processor 22 may generate a message using information received via the communication interface 21 and information stored in the memory 26. The signal processor 22 processes messages received from the relay station 2 and the user terminal 3. At this time, the signal processor 22 stores a processing result of the messages in the memory 26 according to necessity and transmits the messages to the other base stations or MMEs using the communication interface 21.

The transmission processor 23 generates a downlink signal that should be transmitted to the relay station 2 and the user terminal 3. Accordingly, the transmission processor 23 may include an encoder and a modulator. The radio communication circuit 24 outputs a downlink signal generated by the transmission processor 23 via an antenna. In addition, the radio communication circuit 24 receives an uplink signal input via the antenna. Accordingly, the radio communication circuit 24 may include an up-converter that converts the frequency of the downlink signal, a transmission amplifier, a reception amplifier, and a down-converter that converts the frequency of the uplink signal. The reception processor 25 receives uplink signals transmitted from the relay station 2 and the user terminal 3. Accordingly, the reception processor 25 may include a demodulator and a decoder.

Information received from the relay station 2 or the user terminal 3 and information received via the communication interface 21 is stored in the memory 26. A determination result by the radio communication control device 10 is also stored in the memory 26.

The radio communication control device 10 includes a position predictor 11, a transmission path estimator 12, a handover decision unit 13, an estimator 14, and a handover controller 15 in order to determine whether to execute handover for the user terminal 3. Note that the radio communication control device 10 may include other functions not illustrated in FIG. 4.

The position predictor 11 manages the positions of the relay station 2 and the user terminal 3 located in a cell of the base station 1 and predicts positions of the relay station 2 and the user terminal 3. At this time, the position predictor 11 predicts, for example, positions of the relay station 2 and the user terminal 3 in a period from the time t0 to the time t0+αT illustrated in FIGS. 3A and 3B. The time t0 is current time. Note that the user terminal 3 connected to the base station 1 includes a user terminal connected to the base station 1 via the relay station 2 and a user terminal connected to the base station 1 not via the relay station 2.

The transmission path estimator 12 estimates a loss of a transmission path between the base station 1 and the user terminal 3 and a loss of a transmission path between the relay station 2 and the user terminal 3. That is, a loss of a transmission path between the user terminal and a serving BS/RS is estimated. The serving BS/RS represents a base station or a relay station to which the user terminal is connected. The transmission path estimator 12 estimates a loss of a transmission path between the user terminal 3 and a target BS/RS. The target BS/RS is a base station or a relay station other than the serving BS/RS among base stations or relay stations located in the cell of the base station 1. The transmission path estimator 12 calculates received power (RSRP) in the user terminal 3 based on the loss of the transmission path. Therefore, received power RSRP_serv of a signal transmitted from the serving BS/RS and received power RSRP_targ of a signal transmitted from the target BS/RS are calculated.

Note that the transmission path estimator 12 estimates a transmission path based on the positions of the relay station 2 and the user terminal 3 predicted by the position predictor 11. At this time, the transmission path estimator 12 may use a measurement report about RSRP transmitted from the user terminal 3.

The handover decision unit 13 determines based on received power in the user terminal 3 obtained by the transmission path estimator 12 whether a handover condition related to received power is satisfied. For example, when the received power RSRP_targ of a reference signal transmitted from the target BS/RS is larger than the received power RSRP_serv of a reference signal transmitted from the serving BS/RS, the handover decision unit 13 decides that the handover condition is satisfied.

The estimator 14 estimates a communication data amount(without HO) and communication data amount(with HO). The communication data amount(without HO) represents a communication data amount of the user terminal 3 in the throughput estimation period in a case where it is assumed that handover is not executed. The communication data amount(with HO) represents a communication data amount of the user terminal 3 in the throughput estimation period in a case where it is assumed that handover is executed. Note that the estimator 14 may estimate a communication data amount using a loss of the transmission path estimated by the transmission path estimator 12.

The handover controller 15 determines whether a handover condition related to throughput is satisfied. For example, when the communication data amount(with HO) is larger than the communication data amount(without HO), the handover controller 15 decides that the handover condition related to throughput is satisfied. The handover controller 15 controls execution of handover when the handover condition related to received power is satisfied and the handover condition related to throughput is also satisfied.

Note that the radio communication control device 10 is realized by, for example, a microcomputer including a processor and a memory. In this case, functions of the position predictor 11, the transmission path estimator 12, the handover decision unit 13, the estimator 14, and the handover controller 15 are provided by the processor executing a handover control program stored in the memory. However, the function of the radio communication control device 10 may be realized by a hardware circuit.

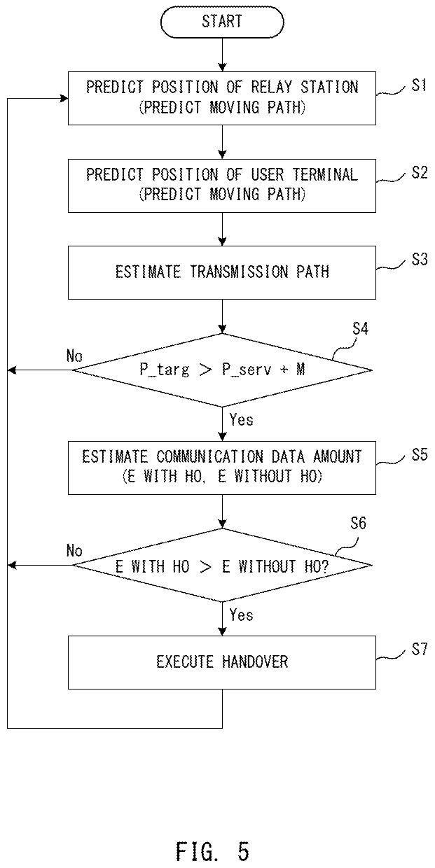

FIG. 5 is a flowchart illustrating an example of the radio communication control method according to the embodiment of the present disclosure. Processing of this flowchart is periodically executed by the radio communication control device 10. The radio communication control device 10 may be implemented in the base station 1 and each of the relay stations 2. Accordingly, this flowchart represents processing of the radio communication control device 10 implemented in the base station 1 or the relay station 2 located in the cell of the base station 1. However, in the following description, it is assumed that this flowchart represents processing of the radio communication control device 10 implemented in the base station 1. In addition, the user terminal 3 can be connected to the base station 1 and the relay station 2. Therefore, in the following description, the base station 1 or the relay station 2 to which the user terminal 3 is connected may be referred to as “serving BS/RS”. The base station 1 and the relay station 2 other than the serving BS/RS may be referred to as “target BS/RS”.

In S1, the position predictor 11 predicts positions of the relay stations 2 located in the cell of the base station 1. Specifically, the position predictor 11 predicts positions of the relay stations 2 in the throughput estimation period (from the time t0 to the time t0+αT) illustrated in FIGS. 3A and 3B. Here, the time t0 is the current time. Then, the position of a relay station 2j is represented by Formula (3). Note that the relay station 2j represents any relay station among the relay stations 2 managed by the base station 1.

A_RSj(τ)=A_RSj(t0)+∫ₜ₀^{τ}V_RSj(t)dt (3)

A_RSj(t0) is a three-dimensional position vector representing the position of the relay station 2j at the time to. When the base station 1 controls the position of the relay station 2j, a position vector of the relay station 2j at the time t0 is known. Otherwise, the position predictor 11 detects the position of the relay station 2j at the time t0. Note that the position predictor 11 can detect the position of the relay station 2j based on a signal transmitted from the relay station 2j. V_RSj(t) is a three-dimensional velocity vector representing the velocity of the relay station 2j. When the base station 1 controls the position of the relay station 2j, a velocity vector of the relay station 2j is known. Otherwise, the position predictor 11 predicts a movement of the relay station 2j. Here, it is assumed that prediction of a movement of an object is realized by a publicly-known technique. A_RSj(τ) is a three-dimensional position vector representing the position of the relay station 2j at time τ. τ represents any time in the throughput estimation period. Therefore, the position predictor 11 can predict positions (that is, a track of movement) of the relay stations 2 in the throughput estimation period.

In S2, the position predictor 11 predicts a position of the user terminal 3 located in the cell of the base station 1. Specifically, the position predictor 11 predicts a position of the user terminal 3 in the period from the time t0 to the time t0+αT illustrated in FIGS. 3A and 3B. Here, the time t0 is the current time. Then, the position of user terminal 3i is represented by Formula (4). Note that the user terminal 3i represents any user terminal among the user terminals 3 located in the cell of the base station 1.

A_UEi(τ)=A_UEi(t0)+∫ₜ₀^{τ}V_UEi(t)dt (4)

A_UEi(t0) is a three-dimensional position vector representing the position of the user terminal 3i at the time to. The position predictor 11 detects the position of the user terminal 3i at the time to. Note that it is assumed that the position predictor 11 can detect the position of the user terminal 3i based on a signal transmitted from the user terminal 3i or a notification from the relay station 2. V_UEi(t) is a three-dimensional velocity vector representing the velocity of the user terminal 3i. The position predictor 11 predicts a movement of the user terminal 3i in the throughput estimation period. A_UEi(τ) is a three-dimensional position vector representing the position of the user terminal 3i at the time τ. Therefore, the position predictor 11 can predict positions (that is, a track of movement) of the user terminal 3 in the throughput estimation period.

In S3, the transmission path estimator 12 estimates a loss of a transmission path between the serving BS/RS and the user terminal 3i in the throughput estimation period. The transmission path estimator 12 calculates, based on the estimated loss of the transmission path, received power P_serv_UEi detected by the user terminal 3i for a reference signal transmitted from the serving BS/RS. At this time, the received power P_serv_UEi at the time τ is represented by Formula (5).

P_serv_UEi(τ)=P_tx+G_serv+G_UEi−PL_serv_UEi(τ) (5)

P_tx represents transmission power of a reference signal transmitted from the serving BS/RS. Note that, in this embodiment, it is assumed that the transmission power of the reference signal used in the radio communication system 100 is the same in all the base stations 1 and the relay stations 2. G_serv represents a gain of a transmission antenna of the serving BS/RS and is assumed to be known. G_UEi represents a gain of a reception antenna of the user terminal. PL_serv_UEi represents a loss of a transmission path between the serving BS/RS and the user terminal 3i.

The transmission path estimator 12 estimates a loss of a transmission path between the target BS/RS and the user terminal 3i in the throughput estimation period. Then, the transmission path estimator 12 calculates, based on the estimated loss of the transmission path, received power P_serv_UEi in the user terminal 3i for a reference signal transmitted from the target BS/RS. At this time, the received power P_targ_UEi at the time τ is represented by Formula (6).

P_targ_UEi(τ)=P_tx+G_targ+G_UEi−PL_targ_UEi(τ) (6)

G_targ represents a gain of a transmission antenna of the target BS/RS and is assumed to be known. PL_targ_UEi represents a loss of a transmission path between the target BS/RS and the user terminal 3i.

In the radio communication system 100, since the relay stations 2 and the user terminals 3 can respectively move, the loss of the transmission path between the BS/RS and the user terminal may change according to elapse of time. That is, the power of a signal transmitted to the user terminal from the BS/RS may change according to elapse of time. Note that a method of estimating a loss of a transmission path is explained below.

In S4, the handover decision unit 13 determines whether a handover condition related to received power is satisfied. Specifically, the handover decision unit 13 determines, based on the received power estimated by the transmission path estimator 12, whether Formula (7) is satisfied.

P_targ_UEi(k−x˜k)>P_serv_UEi(k−x˜k)+Margin (7)

When received power of a signal transmitted from the target BS/RS is larger than a value obtained by adding a specified margin to received power of a signal transmitted from the serving BS/RS in a specified period (in Formula (7), a period from time k−x to time k) in the throughput estimation period, the handover decision unit 13 determines that a handover condition related to the received power is satisfied. That is, it is determined that a state of being connected to the target BS/RS is more advantageous than a state of being connected to the serving BS/RS. In this case, the processing of the radio communication control device 10 proceeds to S5. Note that “x” represents any period shorter than the throughput estimation period. The margin may be determined based on a simulation or the like or may be “zero”.

On the other hand, when the received power of the signal transmitted from the target BS/RS is equal to or smaller than the value obtained by adding the specified margin to the power of the reference signal transmitted from the serving BS/RS, the handover decision unit 13 determines that the handover condition related to the received power is not satisfied. That is, it is determined that the state of being connected to the target BS/RS is more disadvantageous than the state of being connected to the serving BS/RS. In this case, the processing of the radio communication control device 10 ends.

In S5, the estimator 14 estimates throughput of the user terminal that satisfies the handover condition related to the received power. Specifically, the estimator 14 estimates a communication data amount in the throughput estimation period when handover is executed and a communication data amount in the throughput estimation period when handover is not executed. In the example illustrated in FIGS. 3A and 3B, the throughput estimation period is indicated by a period from the current time t0 to the time t0+αT. In this case, a communication data amount E(with HO) in the throughput estimation period when handover is executed is represented by Formula (8).

E(with HO)=∫ₜ₀^{k}(TP before HO)dt+∫_{k+T}^{t0+αT}(TP after HO)dt (8)

k, T, and α are as explained with reference to FIGS. 2 to 3B. That is, k represents time when the handover procedure is started. For example, by estimating a change in received power in a period from the time t0 to the time t0+αT at the time t0, time when the handover condition related to the received power is satisfied is estimated. In this case, k represents time when the handover condition is satisfied. T represents a period during which the handover procedure is executed. The example illustrated in FIG. 2, the period T is equivalent to, for example, a period from HO decision to RRC connection reconfiguration complete. α is a coefficient for designating length of the throughput estimation period. If the throughput estimation period is too long, the accuracy of prediction by the position predictor 11 is likely to be deteriorated. Accordingly, a value of α is preferably determined such that the accuracy of prediction by the position predictor 11 becomes sufficiently high in the entire region of the throughput estimation period. Alternatively, the value of a may be determined by a simulation or the like such that throughput becomes the highest.

Therefore, TP_before_HO represents throughput of communication from the user terminal to the serving BS/RS in a period from the current time to the start of the handover procedure. TP_after_HO represents throughput of communication from the user terminal to the target BS/RS in a period from the end of the handover procedure to the end of the throughput estimation period. Note that, in this example, it is assumed that throughput of the user terminal in a period in which the handover procedure is executed is zero.

A communication data amount E_without_HO in the throughput estimation period in a case where handover is not executed is represented by Formula (9). Note that “TP_without_HO” represents throughput of communication from the user terminal to the serving BS/RS.

E without HO=∫ₜ₀^{t0+ΔT}(TP without HO)dt (9)

Throughput TP (including TP_before_HO, TP_after_HO, and TP_without_HO) is represented by Formula (10).

TP=BW×log₂(1+SINR) (10)

BW represents a bandwidth of a signal. SINR represents, in calculation of TP_before_HO and TP_without_HO, a signal to interference plus noise power ratio for a signal that the serving BS/RS receives from the user terminal. Similarly, SINR represents, in calculation of TP_after_HO, a signal to interference plus noise power ratio for a signal that the target BS/RS receives from the user terminal. Here, the relay station 2 and the user terminal 3 can respectively move. The SINR changes according to the positions of the relay station 2 and the user terminal 3. Therefore, the SINR is not constant and may change according to elapse of time. Estimation of the SINR is explained below.

Note that, in this embodiment, the communication data amount in the throughput estimation period is estimated. However, the embodiment of the present disclosure is not limited to this method. For example, the estimator 14 may estimate average throughput in the throughput estimation period.

In S6, the handover controller 15 determines whether to execute handover based on an estimation result obtained in S5. Specifically, when a communication data amount(E_with_HO) in a case where handover is executed is larger than a communication data amount(E_without_HO) in a case where handover is not executed, the handover controller 15 determines that handover should be executed. In this case, the handover controller 15 executes handover from the serving BS/RS to the target BS/RS in S7.

On the other hand, when the communication data amount(E_with_HO) in a case where handover is executed is smaller than the communication data amount(E_without_HO) in a case where handover is not executed, the handover controller 15 determines that handover should not be executed. In this case, the processing in S7 is skipped.

As explained above, in the radio communication control method according to the embodiment of the present disclosure, it is determined whether to execute handover considering the handover condition related to received power and the handover condition related to throughput. Therefore, even when the handover condition related to received power is satisfied, handover is not executed if the handover condition related to throughput is not satisfied. Therefore, an occurrence frequency of handover decreases and thus a situation in which throughput is deteriorated by executing handover is avoided or suppressed.

Note that the radio communication control device 10 controls handover using an estimated value of throughput in future. However, as time is further apart from the current time, the accuracy of prediction of positions of the relay station 2 and the user terminal 3 is further deteriorated and the accuracy of estimation of throughput decreases. Therefore, the estimator 14 may correct an estimated value of throughput using a correction parameter (or a correction coefficient) that changes according to an elapsed time from the current time.

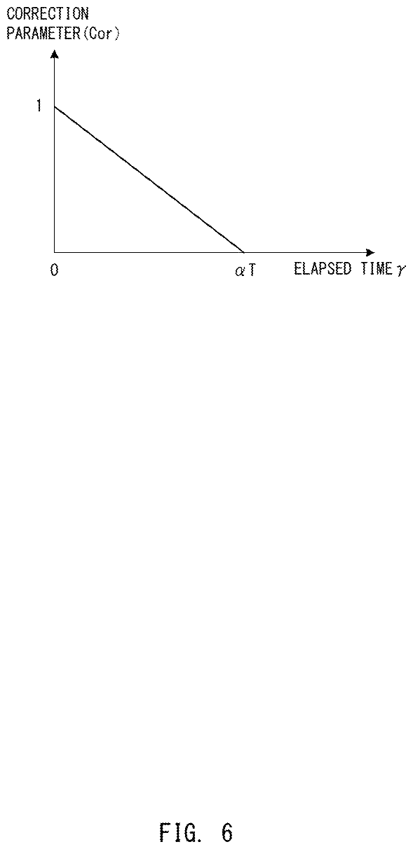

FIG. 6 illustrates an example of a parameter Cor for correcting an estimated value of throughput. The horizontal axis represents an elapsed time γ from the current time. In this embodiment, the correction parameter Cor is represented by Formula (11).

$$Cor ( γ ) = 1 - \frac{γ}{α T} \qquad ( 11 )$$

When the correction parameter is used, the communication data amount(E_with_HO) in a case where handover is executed is represented by Formula (12a) and the communication data amount(E_without_HO) in a case where handover is not executed is represented by Formula (12b).

E with HO=∫ₜ₀^{k}Cor(t)×(TP before HO)dt+∫_{k+T}^{t0++T}Cor(t)×(TP after HO)dt (12a)

E without HO=∫ₜ₀^{t0+αT}Cor(t)×(TP without HO)dt (12b)

When the correction parameter Cor is used, the influence of a time period in which throughput estimation accuracy is low decreases. Accordingly, improvement of the accuracy of determination as to whether to execute handover is expected.

Estimation of a Transmission Path

The transmission path estimator 12 estimates a loss of a transmission path between two radio devices. For example, a loss of a transmission path between the base station 1 and the user terminal 3 and a loss of a transmission path between the relay station 2 and the user terminal 3 are estimated. Here, the loss of the transmission path depends on the distance between the two radio devices and a radio wave environment around the two radio devices.

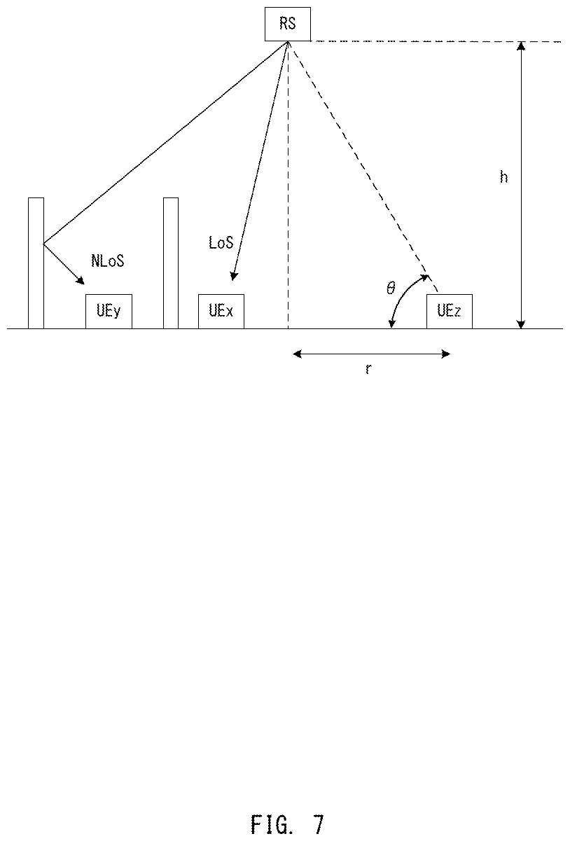

FIG. 7 is a diagram for explaining an estimation of a transmission path. In this example, a radio wave transmitted from a relay station RS directly reaches user terminal UEx without being blocked by an obstacle. That is, a transmission path between the relay station RS and the user terminal UEx is an LOS (Line of sight). In contrast, the radio wave transmitted from the relay station RS cannot directly reach user terminal UEy. A reflected wave (or a diffracted wave) of the radio wave reaches the user terminal UEy. That is, the transmission path between the relay station RS and the user terminal UEy is an NLOS (Non-Line of sight). However, in a general communication environment, the LOS and the NLOS are mixed. Therefore, in order to estimate a loss of a transmission path, it is necessary to calculate an LOS probability and an NLOS probability between the two radio devices.

The LOS probability is represented by Formula (13a) and the NLOS probability is represented by Formula (13b).

$${P}_{L O S} = \frac{1}{1 + a \cdot exp ( - b \cdot [ θ - a ] )} \qquad ( 13 a )$$

$${P}_{NLOS} = 1 - {P}_{L O S} \qquad ( 13 b )$$

$$θ = \frac{180}{π} \cdot arctan ( \frac{h}{r} )$$

θ represents an elevation angle between the relay station RS and the user terminal (in FIG. 7, UEz). r represents a horizontal distance between the relay station RS and the user terminal. h represents the height of a position where the relay station RS is provided. “a” and “b” are respectively specific values corresponding to an environment and are assumed to be known.

As explained above, the LOS probability and the NLOS probability are calculated based on the positions of the two radio devices. Therefore, if positions of the relay station and the user terminal are estimated using Formulas (3) and (4), the LOS probability and the NLOS probability between the relay station and the user terminal can be obtained.

Propagation losses of the LOS and the NLOS are respectively represented by Formulas (14a) and (14b).

$$P {L}_{L O S} = 20 \cdot log ( \frac{4 π \cdot f \cdot d}{c} ) + {η}_{L O S} \qquad ( 14 a )$$

$${PL}_{N L O S} = 20 \cdot log ( \frac{4 π \cdot f \cdot d}{c} ) + {η}_{N L O S} \qquad ( 14 b )$$

f represents a frequency used in the radio communication system. d represents a linear distance between the two radio devices. c represents the speed of light. The first terms of Formulas (14a) and (14b) respectively represent free space path losses and are the same for the LOS and the NLOS. In contrast, η_{LOS} and η_{NLOS} respectively represent additional path losses corresponding to the LOS and the NLOS. The additional path losses are different from each other for the LOS and the NLOS. Note that the additional path losses of the LOS and the NLOS can be respectively calculated based on environments around the two radio devices.

The loss of the LOS is obtained by multiplying the propagation loss of the LOS by the LOS probability. The loss of the NLOS is obtained by multiplying the propagation loss of the NLOS by the NLOS probability. The loss of the transmission path between the two radio devices is represented by the sum of the loss of the LOS and the loss of the NLOS. Accordingly, a transmission path loss PL considering LOS and NLOS is represented by Formula (15).

PL=PL_{LOS}×P_{LOS}+PL_{NLOS}×P_{NLOS} (15)

As explained above, the loss of the transmission path between the two radio devices is calculated based on the positions of the two radio devices. Accordingly, the loss of the transmission path between the serving BS/RS and the user terminal indicated in Formula (5) can be calculated based on the positions of the serving BS/RS and the user terminal. The loss of the transmission path between the target BS/RS and the user terminal indicated in Formula (6) can be calculated based on the positions of the target BS/RS and the user terminal. Here, the positions of the relay stations and the user terminals are predicted using Formulas (3) and (4). Therefore, the transmission path estimator 12 can estimate a loss of the transmission path between the serving BS/RS and the user terminal and a loss of the transmission path between the target BS/RS and the user terminal.

Note that a method of estimating a loss of the transmission path between the two radio devices is described in, for example, the following document.
Bo Hu et al. A Trajectory Prediction Based Intelligent Handover Control Method in UAV Cellular Networks, China Communications, January 2019

The positions of the radio devices (the relay station 2 and the user terminal 3) may be predicted by machine learning. For example, in a case in which the radio devices move along specified paths, when the paths cross one another, it is determined that a collision occurs. In this case, movements of the devices are predicted to avoid a collision. Alternatively, positions of the radio devices may be predicted by the method described in the document Bo Hu described above.

Estimation of Throughput

In the embodiment of the present disclosure, throughput of a signal transmitted from the user terminal to the BS/RS (the base station 1 or the relay station 2) is estimated. Accordingly, first, received power of the BS/RS for the signal transmitted from the user terminal is defined. Formula (16a) represents received power at the time when the base station receives a signal transmitted from the user terminal 3i. Formula (16b) represents received power at the time when the relay station receives the signal transmitted from the user terminal 3i.

P_{Ui_BS}(τ)=P_tx+G_BS+G_UEi−PL_BS_UEi(τ) (16a)

P_{Ui_RS}(τ)=P_tx+G_RS+G_UEi−PL_RS_UEi(τ) (16b)

Note that, since the loss PL of the transmission path substantially depends on only the distance between the two radio devices, the loss PL is the same in a case in which a signal is transmitted from the user terminal to the BS/RS and a case in which a signal is transmitted from the BS/RS to the user terminal.

The throughput between the two radio devices depends on the SINR as indicated by Formula (10). The SINR is calculated based on desired signal power, interference signal power, and noise signal power. Note that, in the following explanation, it is assumed that one or a plurality of relay stations and one or a plurality of user terminals are located in the cell of base station 1. In the following explanation, although throughput of a signal transmitted from the user terminal to the relay station is described, the same applies to throughput of a signal transmitted from the user terminal to the base station.

In the following description, a case in which a user terminal u connected to a relay station RSk transmits a signal and the relay station RSk receives the signal as a desired signal is explained. In this case, at time t, desired signal power S in the relay station RSk is represented by Formula (17). The right side of Formula (17) can be calculated using Formula (16b). That is, the desired signal power S in the relay station RSk can be calculated using Formula (16b).

S_{k,uk}(t)=P_{uk,RSk}(t) (17)

Noise signal power N at the time t is represented by Formula (18). No represents a thermal noise level at normal temperature and is −174. NF represents a noise figure. BW represents a bandwidth of a signal.

N_{k,uk}(t)=N₀+NF+10 log₁₀ BW (18)

In this example, interference signal power is represented by the sum of first interference signal power and second interference signal power. The first interference signal power relates to one or more signals transmitted from one or more user terminals other than the user terminal u among user terminals connected to the relay station RSk. That is, the first interference signal power relates to one or more signals transmitted from other user terminal(s) connected to the relay station RSk. Specifically, when the other user terminal(s) connected to the relay station RSk respectively transmit signal(s) and the relay station RSk receives the signal(s) as interference signal(s), the first interference signal power represents the sum of received power(s) of the interference signal(s). Therefore, the first interference signal power is represented by Formula (19). Note that electric power P in Formula (19) can be calculated using Formula (16b) by predicting positions of the relay station(s) and the user terminal(s).

Iₖ(t)=Σ_{u′k≠u}P_{u′k,RSk}(t) (19)

The second interference signal power relates to signal(s) transmitted from other user terminal(s) connected to relay station(s) other than the relay station RSk. Specifically, when the user terminal(s) connected to the relay station(s) other than the relay station RSk respectively transmit signal(s) and the relay station RSk receives the signal(s) as interference signal(s), the second interference signal power represents the sum of received power(s) of the interference signal(s). That is, the second interference signal power is represented by Formula (20). Note that the electric power P in Formula (20) can be calculated using Formula (16b) by predicting positions of the relay station(s) and the user terminal(s).

I_{k′}(t)=Σ_{k′≠k}Σ_{u′k′}P_{u′k′,RSk}(t) (20)

Therefore, in a case in which the user terminal u connected to the relay station RSk transmits a signal and the relay station RSk receives the signal as a desired signal at the time t, the SINR is represented by Formula (21).

$${SINR}_{k , u k} ( T ) = \frac{{S}_{k , uk} ( T )}{{N}_{k , u k} ( T ) + {I}_{k} ( T ) + {I}_{{k}^{′}} ( T )} \qquad ( 21 )$$

Therefore, if the SINR obtained by Formula (21) is given to Formula (10), it is possible to calculate throughput in a case in which the user terminal u connected to the relay station RSk transmits a signal and the relay station RSk receives the signal as a desired signal.

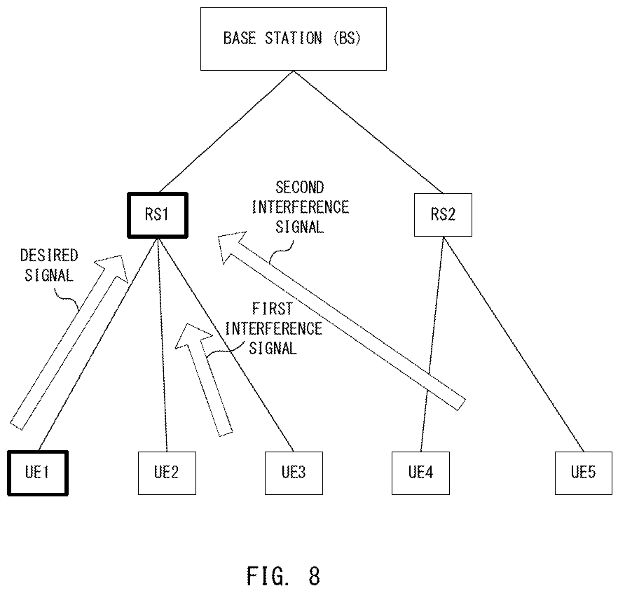

FIG. 8 is a diagram for explaining a calculation of an SINR. In this example, relay stations RS1 and RS2 are connected to a base station BS via a radio link. User terminals UE1 to UE3 are connected to the relay station RS1 via a radio link. User terminals UE4 and UE5 are connected to the relay station RS2 via a radio link.

In this radio communication system, a signal is transmitted from the user terminal UE1, and the relay station RS1 receives the signal as a desired signal. In this case, electric power of the signal received from the user terminal UE1 by the relay station RS1 corresponds to a desired signal power. The user terminals UE2 and UE3 correspond to the other user terminals connected to the relay station RS1. Accordingly, the sum of electric powers of signals received by the relay station RS1 from the user terminals UE2 and UE3 corresponds to the first interference signal power. Further, the relay station RS2 corresponds to a relay station to which the user terminal UE1 is not connected. Therefore, the sum of electric powers of signals received by the relay station RS1 from the user terminals UE4 and UE5 corresponds to the second interference signal power.

Variations

In the embodiment explained above, a communication data amount of the user terminal in the throughput estimation period is calculated assuming that throughput during handover (in FIG. 3A, TP_during_HO) is zero. Then, it is determined whether to execute handover based on the communication data amount. However, the present disclosure is not limited to this embodiment.

For example, when being implemented in the base station 1, the radio communication control device 10 may determine whether to execute handover considering the throughput of the entire radio communication system. In this case, the estimator 14 estimates total throughput of all user terminals located in the cell of the base station 1. Here, when handover for one user terminal is being executed, the other user terminals can continue communication. Therefore, in estimating a communication data amount in a case where handover is executed, it is preferable to also consider throughput during handover (in the example illustrated in FIGS. 3A and 3B, a period from time k to time k+T).

Simulation

The inventor of the present application compared throughputs of a method of determining whether to execute handover based on only a handover condition related to received power (hereinafter, comparative method) and a method of determining whether to execute handover based on a handover condition related to received power and a handover condition related to throughput (hereinafter, embodiment method). Parameters in the simulation are as follows.

### Frequency: 28 GHz

### Bandwidth: 400 MHz

Cell radius of the base station: 300 meters
Number of relay stations: 3
Number of user terminals: 3
Moving speed of the relay station: 8 meters/second
Time granularity of the simulation: 0.01 seconds
Evaluation time: 75 seconds
Number of trials: 100

As a result of the simulation, among one hundred times of trials, the throughput of the embodiment method was higher than that of the comparative method in 62 times of trials and throughputs of the comparative method and the embodiment method were the same in 38 times of trials. Note that the length of the throughput estimation period illustrated in FIGS. 3A and 3B is preferably determined such that, for example, throughput is higher in the simulation explained above.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosures have been described in detail, it should be understood, that the various changes, substitutions, and alterations could be made hereto without departing from the spirit and scope of the disclosure.

What is claimed is:

1. A radio communication control device that controls handover of a user terminal in a radio communication system including a base station and a mobile relay station, the radio communication control device comprising:
a processor configured to
determine whether a handover condition is satisfied based on a received power of a radio signal detected by the user terminal, the radio signal being transmitted from the base station or the relay station,
estimate a first communication amount representing a communication amount of the user terminal in an estimation period in a case where the handover is executed and a second communication amount representing a communication amount of the user terminal in the estimation period in a case where the handover is not executed, and
control an execution of the handover of the user terminal when the handover condition is satisfied and the first communication amount is larger than the second communication amount.

2. The radio communication control device according to claim 1, wherein
the processor predicts positions of the relay station and the user terminal in the estimation period, and
the processor estimates the first communication amount and the second communication amount based on the predicted positions of the relay station and the user terminal.

3. The radio communication control device according to claim 1, wherein
the estimation period includes:
a first period from current time to time when the handover condition is satisfied;
a second period from an end of the first period until an execution time of the handover elapses; and
a third period from an end of the second period to an end of the estimation period,
the first communication amount represents a sum of a communication amount of a signal transmitted from the user terminal to a serving station of the user terminal in the first period and a communication amount of a signal transmitted from the user terminal to a target station of the handover of the user terminal in the third period, and
the second communication amount represents a communication amount of a signal transmitted from the user terminal to the serving station in the estimation period.

4. The radio communication control device according to claim 1, wherein
the estimation period includes:
a first period from current time to time when the handover condition is satisfied;
a second period from an end of the first period until an execution time of the handover elapses; and
a third period from an end of the second period to an end of the estimation period,
the processor
predicts positions of the relay station and the user terminal in the estimation period,
estimates first throughput representing throughput of communication from the user terminal to a serving station of the user terminal in the first period based on the predicted positions of the relay station and the user terminal,
estimates second throughput representing throughput of communication from the user terminal to a target station of the handover of the user terminal in the third period based on the predicted positions of the relay station and the user terminal, and
calculates the first communication amount based on the first throughput and the second throughput.

5. The radio communication control device according to claim 4, wherein
the processor estimates third throughput representing throughput of communication from the user terminal to the serving station of the user terminal in the estimation period based on the predicted positions of the relay station and the user terminal and calculates the second communication amount based on the third throughput.

6. The radio communication control device according to claim 5, wherein
the processor multiplies the first throughput, the second throughput, and the third throughput respectively by a correction parameter, a value of the correction parameter decreases according to elapse of time.

7. A radio communication control method for controlling handover of a user terminal in a radio communication system including a base station and a mobile relay station, the method comprising:
determining whether a handover condition is satisfied based on a received power of a radio signal detected by the user terminal, the radio signal being transmitted from the base station or the relay station;
estimating a first communication amount representing a communication amount of the user terminal in an estimation period in a case where the handover is executed and a second communication amount representing a communication amount of the user terminal in the estimation period in a case where the handover is not executed; and
controlling an execution of the handover of the user terminal when the handover condition is satisfied and the first communication amount is larger than the second communication amount.
